(19) United States
(12) Patent Application Publication
(10) Pub. No.: US 2007/0036181 A1
(43) Pub. Date: Feb. 15, 2007

(54) Transmission device, network management method, and computer product

(75) Inventor: Hidemasa Nagasawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/288,361

(22) Filed: Nov. 29, 2005

(30) Foreign Application Priority Data
Aug. 9, 2005 (JP) 2005-231142

(51) Int. Cl. H04J 3/16; H04J 3/22; H04J 3/04

(52) U.S. Cl. 370/536; 370/437; 370/465

(57) ABSTRACT

A plurality of physically different physical paths is used as virtually one virtual path. A transmission device, which is a sender of a main signal, monitors transmission status of a main signal and changes currently used physical path to another physical path based on the transmission status. When the physical path is changed, information relating to the new physical path is sent to a transmission device that is a destination of the main signal.

### CROSS-REFERENCE TO RELATED APPLICATIONS

This application is based upon and claims the benefit of priority from Japanese Patent Application No. 2005-231142 filed on Aug. 9, 2005, the entire contents of which are incorporated herein by reference.

### BACKGROUND OF THE INVENTION

1. Field of the Invention

The present invention relates to a technology for dynamically and automatically adjusting bands in a synchronous digital hierarchy (SDH), a synchronous optical network (SONET), and the like.

2. Description of the Related Art

There is known a communication technology SONET/SDH that is the basis of the information communication infrastructure. In SONET/SDH, bands can be transmitted certainly. As a result, in SONET/SDH, when packet communication is performed in the same manner as the Internet, idle information must be transmitted fixedly even if there is enough capacity to perform communications. Virtual concatenation (VCAT) and link capacity adjustment scheme (LCAS) have been studied as techniques that do not have the drawbacks of the SONET/SDH.

The VCAT is a method of using a plurality of physically different paths as virtually one path. The LCAS is a method of dynamically increasing or decreasing bands to be used corresponding to the situation of traffic (data packets). Actually, the functions of the VCAT and LCAS are mixed and used, thereby controlling more complicated and high-degree lines (bands). By applying these techniques, when a fault occurs on a network, the line capacity is automatically increased. On the other hand, when the fault on the network is restored, the capacity can be automatically decreased. To do this, it is necessary to check and manage the operation status (status of use of the bands) having the possibility of changes moment by moment accurately at an appropriate timing.

Known techniques for dynamically adjusting the bands by applying the VCAT and the LCAS to the SONET/SDH include the following example. That is, it is a network system having a transmission device that sets a plurality of channels by using a plurality of bands for a transmission path by multiplexing and transmits data, and a management device that manages the transmission device. The management device includes a channel path management unit that receives a channel path setting request from a sender transmission device to a destination transmission device and performs routing of a channel satisfying the path setting request, and a channel setting instruction unit that transmits a channel setting instruction to the transmission device. The transmission device includes a channel path setting unit that sets a channel path based on the channel setting instruction, a multiplexer that multiplexes data and transmits the data based on the channel path, and a band adjusting unit that detects idle bands in the transmission path, appropriately distributes the idle bands corresponding to the number of channel requests, and outputs a path setting request for changing the number of channels based on the distribution result. A related technology has been disclosed in Japanese Patent Application Laid-open No. 2004-153623.

In the network system disclosed in Japanese Patent Application Laid-open No. 2004-153623, however, the management device sets the channel and issues an instruction with respect to the path setting request for changing the number of channels from the transmission device, thereby changing the number of channels. Therefore, there is a problem in that the network system cannot instantaneously correspond to changes in quite short time, such as abrupt increase or decrease in the traffic amount, and occurrence and restoration of a fault on the network, which take place frequently in the packet communication.

### SUMMARY OF THE INVENTION

It is an object of the present invention to at least solve the problems in the conventional technology.

According to an aspect, a transmission device that uses a plurality of physically different physical paths as virtually one virtual path includes a band managing unit configured to monitor transmission status of a main signal and change a currently used physical path to another physical path in the virtual path based on the transmission status; and a path trace managing unit configured to transmit information about the another physical path to a transmission device that is a destination of transmission of the main signal.

According to another aspect, a network management method of using a plurality of physically different physical paths as virtually one virtual path includes monitoring transmission status of a main signal; changing a currently used physical path to another physical path in the virtual path based on the transmission status; and transmitting information about the another physical path to a transmission device that is a destination of transmission of the main signal.

According to still another aspect, a computer-readable recording medium stores therein a computer program that causes a computer to implement a transmission method according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an example of the configuration of a network system according to an embodiment of the present invention;

FIG. 2 is an example of the configuration of an NMS;

FIG. 3 is an example of the configuration of an NE;

FIG. 4 is a flowchart of of a network management method; and

FIG. 5 is an example of a mounting location of J1 byte.

### DETAILED DESCRIPTION OF THE PREFERRED EMBODIMENTS

Exemplary embodiments of the present invention will be explained below in detail with reference to the accompanying drawings.

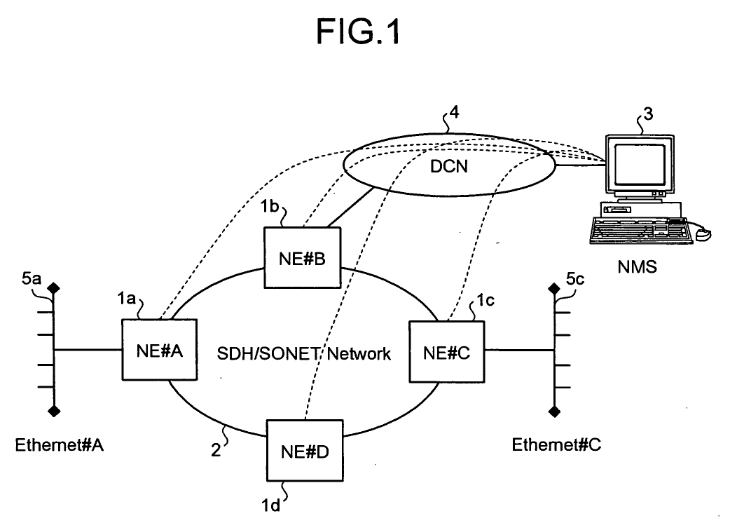

In the following embodiments, the transmission device that is an element constituting the network is expressed as a network element (NE), and a management device that manages the entire network formed of NEs is expressed as a network management system (NMS). When it is necessary to discriminate each NE constituting the network, discrimination is done by adding #* (* means alphabet) after the NE (the same applies to the Ethernet (registered trademark) in FIG. 1.

FIG. 1 is an example of the configuration of a network system according to a first embodiment of the present invention. As shown in FIG. 1, in a network such as the SONET/SDH, a ring network 2 is formed of, for example, four NEs, that is, NE#A 1a, NE#B 1b, NE#C 1c, and NE#D 1d, though not particularly limited. The respective NEs 1a, 1b, 1c, and 1d are connected with each other by an optical signal of STM-N (N is 1/4/16/64), and connected to an NMS 3 via a data communication network (DCN) 4.

The respective NEs 1a, 1b, 1c, and 1d are respectively connected to the Ethernet. That is, these Ethernets are connected with each other via the ring network 2. It is assumed that the Ethernet#A 5a connected to the NE#A 1a and the Ethernet#C 5c connected to the NE#C 1c are interfaced with each other by Gigabit (GbE) Ethernet and the like. In the example shown in FIG. 1, the NE#B 1b is directly connected to the DCN 4, and the other NE#A 1a, NE#C 1c, and NE#D 1d are indirectly connected to the DCN 4 by an overhead byte in the optical signal. However, the NE#A 1a, NE#C 1c, and NE#D 1d can be directly connected to the DCN 4.

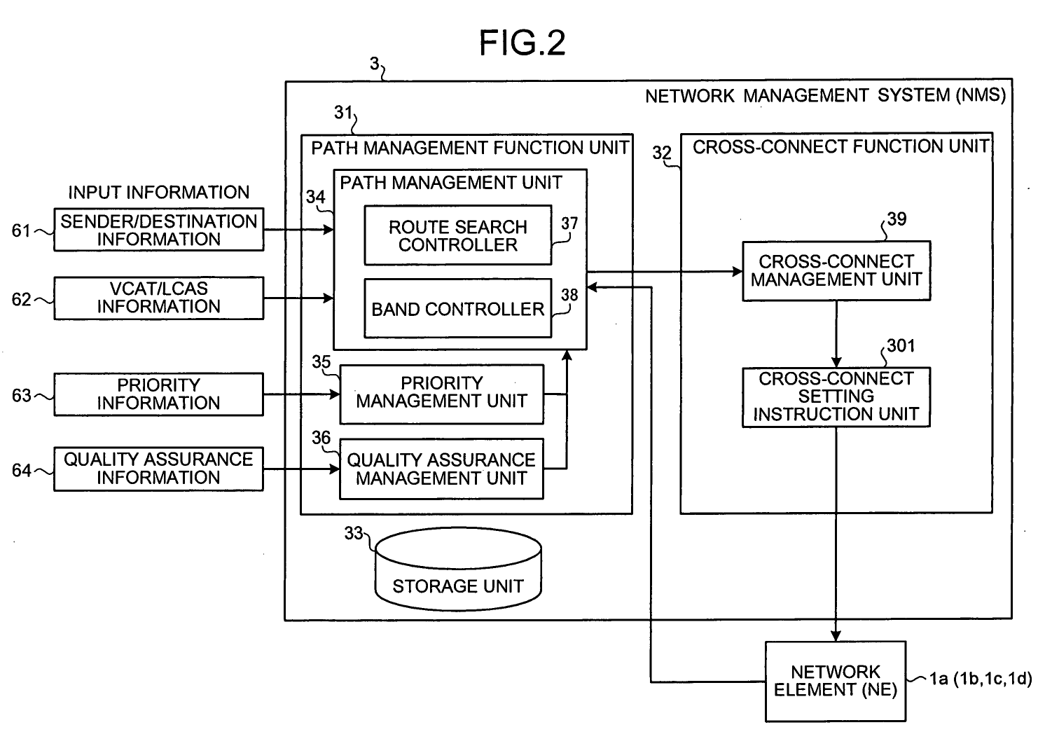

FIG. 2 is an example of the configuration of the NMS. As shown in FIG. 2, the NMS 3 includes a path management function unit 31, a cross-connect function unit 32, and a storage unit 33. The path management function unit 31 includes a path management unit 34, a priority management unit 35, and a quality assurance management unit 36. The path management unit 34 includes a route search controller 37 and a band controller 38. The cross-connect function unit 32 includes a cross-connect management unit 39 and a cross-connect setting instruction unit 301. The NMS 3, and the path management function unit 31 or the cross-connect function unit 32 in the NMS 3 include units for realizing various functions, however, since these units are not the essential parts of the present invention, the explanation thereof is omitted.

Sender/destination information 61, VCAT/LCAS information 62, priority information 63, and quality assurance information 64 are input to the NMS 3 by a user such as a network manager, as a request condition to the path to be set. The sender/destination information 61 relates to the NE as a sender device and a destination device of the path to be set. The VCAT/LCAS information 62 relates to the VCAT/LCAS. The priority information 63 relates to the importance of data packets passing through the path to be set. The quality assurance information 64 relates to the quality level to be guaranteed by the path to be set.

The route search controller 37 searches the presence of an unused capacity that can be used as a path and a connectable route based on the sender/destination information 61. The band controller 38 dynamically optimizes line bands corresponding to the traffic amount by the VCAT/LCAS. The priority management unit 35 manages the priority of the respective paths specified by the user based on the priority information 63, and supplies information relating to the priority of the respective paths to the path management unit 34. The quality assurance management unit 36 manages the request quality condition with respect to the respective paths specified by the user based on the quality assurance information 64, and supplies information relating to the quality assurance of the respective paths to the path management unit 34.

The path management unit 34 supplies comprehensive path information to the cross-connect management unit 39, which includes the route information obtained by the search by the route search controller 37, the priority information supplied from the priority management unit 35, and the quality assurance information supplied from the quality assurance management unit 36 as attribute information. The cross-connect management unit 39 extracts cross-connect information to be set with respect to the respective NEs present on the route of the respective paths based on the path information received from the path management unit 34, and supplies the cross-connect information to the cross-connect setting instruction unit 301 together with additional information. The cross-connect setting instruction unit 301 converts the cross-connect information and the additional information for each NE received from the cross-connect management unit 39 to a specific cross-connect setting command, and transmits the cross-connect setting command to the respective NEs.

The path management unit 34 obtains status information indicating the presence of traffic in the respective paths from the NE as the destination device, after the path to be set is set, associates the status information with the set path, and registers the associated status information and set path in a database in the storage unit 33. When some change occurs in the path, under such a state that the path to be set has been already set and is operated, the path management unit 34 receives a status change report of the path transmitted from the NE as the destination device, recognizes a status change based on the status change report, and updates the database registered in the storage unit 33.

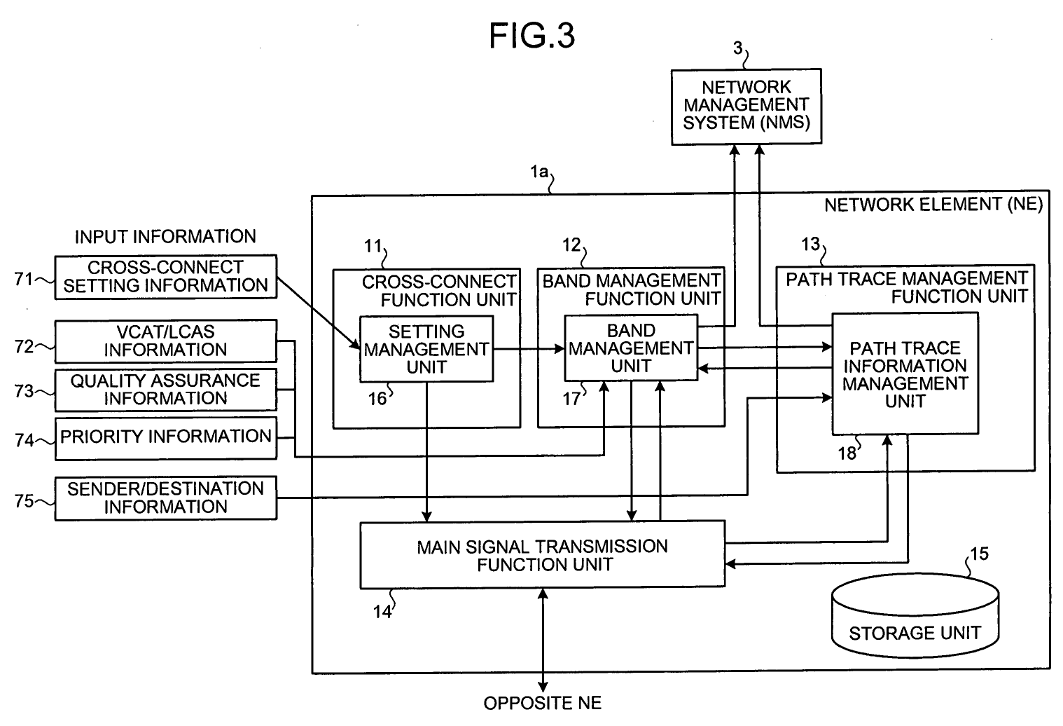

FIG. 3 is an example of the configuration of the NE. Since the NEs 1a, 1b, 1c, and 1d have the same configuration, the configuration of the NE#A 1a will be explained. As shown in FIG. 3, the NE#A 1a includes a cross-connect function unit 11, a band management function unit 12, a path trace management function unit 13, a main signal transmission function unit 14, and a storage unit 15. The cross-connect function unit 11, the band management function unit 12, and the path trace function unit 13 respectively include a setting management unit 16, a band management unit 17, and a path trace information management unit 18. Additionally, units for realizing various functions are provided in the NE#A 1a and respective function units 11, 12, and 13, however, since these units are not the essential parts of the present invention, the explanation thereof is omitted.

The NMS 3 inputs cross-connect setting information 71, VCAT/LCAS information 72, quality assurance information 73, priority information 74, and sender/destination information 75 to the NE#A 1a. These various kinds of information can be obtained by breaking down the cross-connect setting command received from the NMS 3 by a reception processor (not shown). The cross-connect setting information 71 relates to setting of the cross-connect. The VCAT/LCAS information 72 relates to the VCAT/LCAS. The quality assurance information 73 relates to the quality level to be guaranteed by the path to be set. The priority information 74 relates to the importance of data packets passing through the path to be set. The sender/destination information 75 relates to the NE as a sender device and a destination device of the path to be set. The sender/destination information 75, the priority information 74, and the quality assurance information 73 are registered in the database in the storage unit 15.

The setting management unit 16 sets the cross-connect based on the cross-connect setting information 71, and informs the set content to the band management unit 17. The band management unit 17 always monitors the transmission condition of the main signal, and controls the line bands based on the VCAT/LCAS information 72, the quality assurance information 73, and the priority information 74. Specifically, the band management unit 17 performs following controls. That is, when the capacity is not sufficient in the current bands due to an increase in the traffic, the band management unit 17 directs the traffic to an unused path. When there is an unused path in the current bands due to a decrease in the traffic amount, the band management unit 17 concentrates the traffic on a selected path, and makes other paths idle.

Furthermore, when a fault occurs in a certain path, the path is changed over based on the priority specified by a user beforehand, to relieve the traffic going through the path in which the fault has occurred. When the line quality of a certain path falls below the quality specified by the user beforehand, the path is changed over, by comprehensively determining the status of use of other paths, the line quality, and the priority. When an NE becomes a sender device, the band management unit 17 notifies the status of each path changed by the control of the line bands to the path trace information management unit 18. The path trace information management unit 18 in the NE that becomes the sender device inserts the sender/destination information 75 and the status information informed from the band management unit 17 in the path trace data, and transmits the path trace data to the opposite NE (the NE that becomes the destination device) via the overhead byte.

On the other hand, in the NE that becomes the destination device, the path trace information management unit 18 extracts the status information from the path trace data transmitted from the opposite NE (the NE that becomes the sender device) via the overhead byte in the main signal. The band management unit 17 in the NE as the destination device monitors the status information extracted by the path trace information management unit 18, and when having detected a status change, transmits a status change report to the NMS 3. When the NE is the destination device, the path trace information management unit 18 extracts information from the overhead byte in the path trace data transmitted from the opposite NE (the NE that becomes the sender device), and compares the reception expectation value based on the sender/destination information 75 with the actual reception value, to confirm conduction of path between the opposite ends. The path trace information management unit 18 supplies the status information to the band management unit 17. In the NE, the path and the status information thereof are registered in the database in the storage unit 15.

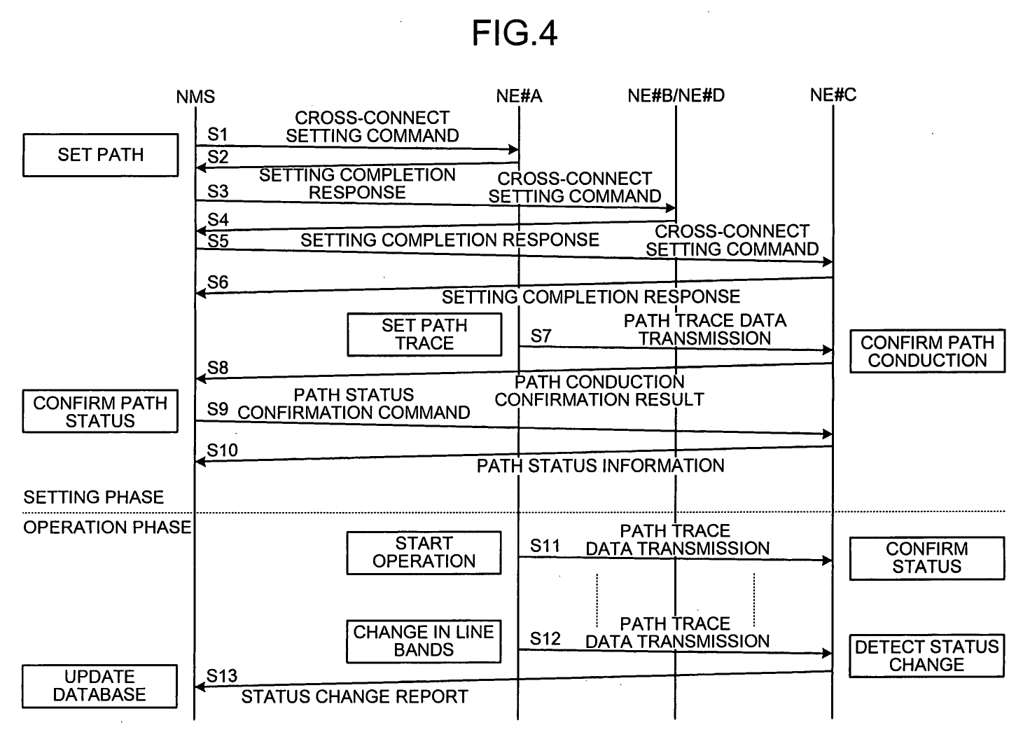

FIG. 4 is an example of a sequence from path setting to operation start. For convenience sake, in the system shown in FIG. 1, an example in which a VC4-8V path is set between the NE#A 1a as the sender device and the NE#C 1c as the destination device, and the main signal from the NE#A 1a to the NE#C 1c is relayed by the NE#B 1b or the NE#D 1d will be explained.

As shown in FIG. 4, to set the path, a user inputs the sender/destination information 61, the VCAT/LCAS information 62, the priority information 63, and the quality assurance information 64 to the NMS 3. Upon reception of these pieces of information, the NMS 3 checks the idle state of the line in the path management unit 34 and searches and confirms the route. If there is no problem, the path management unit 34 transmits comprehensive path information to the cross-connect management unit 39, which includes the searched route information, the priority information supplied from the priority management unit 35, and the quality assurance information supplied from the quality assurance management unit 36 as attribute information.

An example of the attribute information is shown in Table 1 for eight paths, with the path ID #1 to #8.

TABLE 1

| Path | Sender | Destination | | Quality |
|---|---|---|---|---|
| ID | device ID | device ID | Priority | assurance level |
| #1 | NE#A | NE#C | High | EB = a, ES = b, |
| | | | | SES = c, UAS = d, |
| | | | | BBE = e |
| #2 | NE#A | NE#C | High | EB = a, ES = b, |
| | | | | SES = c, UAS = d, |
| | | | | BBE = e |
| #3 | NE#A | NE#C | Low | EB = a, ES = b, |
| | | | | SES = c, UAS = d, |
| | | | | BBE = e |
| #4 | NE#A | NE#C | Low | EB = a, ES = b, |
| | | | | SES = c, UAS = d, |
| | | | | BBE = e |
| #5 | NE#A | NE#C | High | EB = a, ES = b, |
| | | | | SES = c, UAS = d, |
| | | | | BBE = e |
| #6 | NE#A | NE#C | High | EB = a, ES = b, |
| | | | | SES = c, UAS = d, |
| | | | | BBE = e |
| #7 | NE#A | NE#C | Low | EB = a, ES = b, |
| | | | | SES = c, UAS = d, |
| | | | | BBE = e |
| #8 | NE#A | NE#C | Low | EB = a, ES = b, |
| | | | | SES = c, UAS = d, |
| | | | | BBE = e |

Upon reception of the path information from the path management unit 34, the cross-connect management unit 39 extracts the cross-connect information to be set with respect to all NEs present on the route of the respective paths, that is, the respective NEs 1a, 1b, 1c, and 1d. The cross-connect management unit 39 transmits the extracted cross-connect information together with other additional pieces of information to the cross-connect setting instruction unit 301. Upon reception of the cross-connect information of the respective NEs 1a, 1b, 1c, and 1d and the additional information from the cross-connect management unit 39, the cross-connect setting instruction unit 301 converts these pieces of information to a cross-connect setting command and transmits the command to the respective NEs 1a, 1b, 1c, and 1d (steps S1, S3, and S5).

Upon reception of the cross-connect setting command, the respective NEs 1a, 1b, 1c, and 1d respectively perform the cross-connect setting. When having completed the cross-connect setting, the respective NEs 1a, 1b, 1c, and 1d give a setting completion response to the NMS 3 (steps S2, S4, and S6). The NE#A 1a as the sender device and the NE#C 1c as the destination device reuse the attribute information (see Table 1) included in the cross-connect setting command as data for a path/trace function held by the SONET/SDH device, and set a transmission value and the reception expectation value in the respective path trace information management unit 18. An example of the data for the path trace function is shown in Table 2.

A setting example of the data for the path trace function is shown in Table 2.

TABLE 2

| Device | | Reception expectation |
|---|---|---|
| ID | Transmission value | value |
| NE#A | <Sender device ID> + | <Destination device ID> + |
| | <path ID> | <path ID> |
| NE#B | Null | Null |
| NE#C | <Destination device ID> + | <Sender device ID> + |
| | <path ID> | <path ID> |
| NE#D | Null | Null |

The NE#A 1a as the sender device executes the path trace function for confirming conduction by the path trace setting at the time of completing the own cross-connect setting, and transmits the path trace data to the NE#C 1c (step S7). When the cross-connect setting has not been completed yet in the NE#B 1b, NE#D 1d, and NE#C 1c, various errors or alarm can occur. However, in the NE#B 1b, NE#C 1c, and NE#D 1d, when a series of processing is normally executed and setting is completed, all these errors will be solved. The NE#C 1c issues the path conduction confirmation result, upon confirmation of the conduction of the path, and the NMS 3 receives the path conduction confirmation result (step S8).

To confirm the path status, the NMS 3 transmits a path status confirmation command to the NE#C 1c (step S9). Upon reception of the path status confirmation command, the NE#C 1c returns the status information of the respective paths to the NMS 3 (step S10). As shown in Table 3, there are four kinds of path status, for example, “WK”, “IDLE”, “OOS”, and “FAULT”. “WK” indicates a usable state, and is used for passage of the traffic. “IDLE” indicates a usable state, but is not used for passage of the traffic. “OOS” indicates that the usable state has not been established yet. “FAULT” indicates an unusable state due to a fault.

A display example of the path status is shown in Table 3.

TABLE 3

| No. | Path status | Operation status |
|---|---|---|
| 1 | WK | Being used (traffic is passing) |
| 2 | IDLE | Being used (traffic has not |
| | | passed yet) |
| 3 | OOS | Not usable (unused state) |
| 4 | FAULT | Not usable (fault occurred) |

A setting phase finishes here. After this, an operation phase starts, and the actual operation is started according to user's instructions. For convenience' sake, it is assumed that, as shown in Table 4, four paths, #1 to #4 are set on the route via the NE#B (NE#A-NE#B-NE#C), and four paths, #5 to #8 are set on the route via the NE#D (NE#A-NE#D-NE#C), thereby forming a VC4-8V path between the NE#A and the NE#C.

An example of the status information in the NE#C 1c at the time of starting the operation is shown in Table 4.

TABLE 4

| | Status information in NE#C | | | |
|---|---|---|---|---|
| Path | Received | Notified | Variable | |
| ID | information | information | factor | Route |
| #1 | WK | WK | — | NE#A-NE#B-NE#C |
| #2 | WK | WK | — | NE#A-NE#B-NE#C |
| #3 | WK | WK | — | NE#A-NE#B-NE#C |
| #4 | IDLE | IDLE | — | NE#A-NE#B-NE#C |
| #5 | IDLE | IDLE | — | NE#A-NE#D-NE#C |
| #6 | IDLE | IDLE | — | NE#A-NE#D-NE#C |
| #7 | IDLE | IDLE | — | NE#A-NE#D-NE#C |
| #8 | IDLE | IDLE | — | NE#A-NE#D-NE#C |

As shown in Table 4, it is assumed that the status of the paths #1 to #3 is set to “WK” and the status of the paths “4 to #8 is set to “IDLE”. The NMS 3 collects the status information of the respective paths from the NE#C 1c and registers the status information in the database in the storage unit 33, before starting the operation. When there is an information service request from the user, the NMS 3 offers the information registered in the database.

During the operation, the NE#A 1a always executes the path trace function, and continues to transmit the path trace data to the NE#C 1c (steps S11 and S12). The NE#C 1c always confirms the status. During the operation, when having detected a status change, due to fluctuations in the line bands, the NE#C 1c transmits a status change report to the NMS 3 (step S13). The operation of the NE#A 1a, NE#C 1c, and NMS 3 when fluctuations or the like occur in the line bands during the operation will be specifically explained, taking examples when the traffic increases, the traffic decreases, and the traffic is relieved.

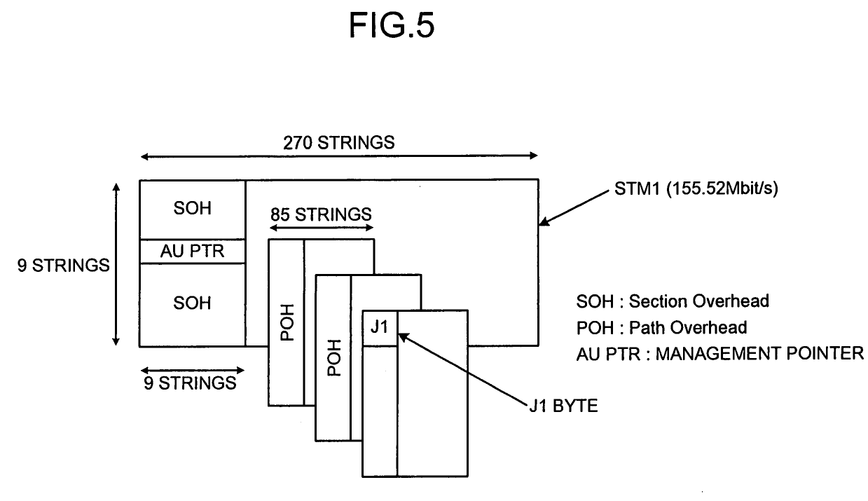

When the traffic amount starts to increase under the operation status shown in Table 4 and the capacity starts to be not sufficient in the paths #1 to #3, the band management unit 17 of the NE#A 1a as the sender detects the matter. The band management unit 17 of the NE#A 1a directs a part of the traffic to the path #4 in the “IDLE” state by the LCAS function, and also notifies the path trace information management unit 18 of the NE#A 1a that the status of the path #4 is changed from “IDLE” to “WK”. Upon reception of the status change notification, the path trace information management unit 18 of the NE#A 1a transmits status change information (included in path trace data) to the NE#C 1c as the destination via the overhead byte (J1 byte, see FIG. 5) of the main signal.

In the NE#C 1c, which is the destination, the band management unit 17 detects that the status of the path #4 has changed based on the status change information transmitted from the NE#A 1a, which is the sender. The NE#C 1c, which is the destination, then transmits the status change report including the path name, the status after the change, and the variable factor, for example “#4, WK, increase”, to the NMS 3. Upon reception of the status change report from the NE#C 1c, the NMS 3 recognizes the status change of the path #4 by the path management unit 34, and registers the content of the status change and the factor, for example as “#4, IDLE→WK, increase”, to update the database.

The operation status after the status change of the path #4 is shown in Table 5.

TABLE 5

| | Status information in NE#C | | | |
|---|---|---|---|---|
| Path | Received | Notified | Variable | |
| ID | information | information | factor | Route |
| #1 | WK | WK | — | NE#A-NE#B-NE#C |
| #2 | WK | WK | — | NE#A-NE#B-NE#C |
| #3 | WK | WK | — | NE#A-NE#B-NE#C |
| #4 | WK | WK | Increase | NE#A-NE#B-NE#C |
| #5 | IDLE | IDLE | — | NE#A-NE#D-NE#C |
| #6 | IDLE | IDLE | — | NE#A-NE#D-NE#C |
| #7 | IDLE | IDLE | — | NE#A-NE#D-NE#C |
| #8 | IDLE | IDLE | — | NE#A-NE#D-NE#C |

When the traffic amount starts to decrease under the operation status shown in Table 4, and there is a space in the bands of the paths #1 to #3, the band management unit 17 of the NE#A 1a, which is the sender, detects currently unused bands. The band management unit 17 of the NE#A 1a then directs all the traffic to the paths #1 and #2 by the LCAS function, so as to make the path #3 idle. At the same time, the band management unit 17 of the NE#A 1a notifies the path trace information management unit 18 of the NE#A 1a that the status of the path #3 is changed from “WK” to “IDLE”.

Processing after this is the same as in the traffic increase. That is, the path trace information management unit 18 of the NE#A 1a transmits a status change of the path #3 to the NE#C 1c, which is the destination, via the J1 byte. The NE#C 1c transmits a status change report, for example, “#3, IDLE, decrease” to the NMS 3. The NMS 3 updates the database for the path #3, for example, as “#3, IDLE, decrease”

The operation status after the status change of the path #3 is shown in Table 6.

TABLE 6

| | Status information in NE#C | | | |
|---|---|---|---|---|
| Path | Received | Notified | Variable | |
| ID | information | information | factor | Route |
| #1 | WK | WK | — | NE#A-NE#B-NE#C |
| #2 | WK | WK | — | NE#A-NE#B-NE#C |
| #3 | IDLE | IDLE | Decrease | NE#A-NE#B-NE#C |
| #4 | IDLE | IDLE | — | NE#A-NE#B-NE#C |
| #5 | IDLE | IDLE | — | NE#A-NE#D-NE#C |
| #6 | IDLE | IDLE | — | NE#A-NE#D-NE#C |
| #7 | IDLE | IDLE | — | NE#A-NE#D-NE#C |
| #8 | IDLE | IDLE | — | NE#A-NE#D-NE#C |

When a line disconnection occurs somewhere in the route of NE#A-NE#B-NE#C under the operation status shown in Table 4, the band management unit 17 of the sender NE#A la directs all the traffic to the paths #5 to #7 by the LCAS function, changes the status of the paths #5 to #7 from “IDLE” to “WK”, and notifies the path trace information management unit 18 of the NE#A 1a of the status change. The path trace information management unit 18 of the NE#A la transmits a status change report of the paths #5 to #7 to the destination NE#C 1c via the J1 byte.

On the other hand, the band management unit 17 of the destination NE#C 1c detects that the status of the paths #5 to #7 have been changed, and also detects that the NE#A 1a has not transmitted anything through the paths #1 to #4, to change the status of the paths #1 to #4 from “WK” to “FAULT”. The NE#C 1c transmits a status change report to the NMS 3, such as “#1, FAULT, connection failure”, “#2, FAULT, connection failure”, “#3, FAULT, connection failure”, “#4, FAULT, connection failure”, “#5, WK, connection failure”, “#6, WK, connection failure”, and “#7, WK, connection failure”. The NMS 3 updates the database for the paths of #1 to #4, for example, as “#1, WK→FAULT, connection failure”, “#2, WK→FAULT, connection failure”, “#3, WK→FAULT, connection failure”, “#4, WK→FAULT, connection failure”, and for the paths of #5 to #7 for example as “#5, IDLE→WK, connection failure”, “#6, IDLE→WK, connection failure”, and “#7, IDLE→WK, connection failure”.

The operation status after the status change of the paths #1 to #7 is shown in Table 7.

TABLE 7

| | Status information in NE#C | | | |
|---|---|---|---|---|
| Path | Received | Notified | Variable | |
| ID | information | information | factor | Route |
| #1 | — | FAULT | Connection | NE#A-NE#B- |
| | | | failure | NE#C |
| #2 | — | FAULT | Connection | NE#A-NE#B- |
| | | | failure | NE#C |
| #3 | — | FAULT | Connection | NE#A-NE#B- |
| | | | failure | NE#C |
| #4 | — | FAULT | Connection | NE#A-NE#B- |
| | | | failure | NE#C |
| #5 | WK | WK | Connection | NE#A-NE#D- |
| | | | failure | NE#C |
| #6 | WK | WK | Connection | NE#A-NE#D- |
| | | | failure | NE#C |
| #7 | WK | WK | Connection | NE#A-NE#D- |
| | | | failure | NE#C |
| #8 | IDLE | IDLE | — | NE#A-NE#D- |
| | | | | NE#C |

As shown in Table 8, it is assumed here that the status of the paths #1, #2, and #5 to #7 is “WK”, and the status of the paths #3, #4, and #8 is “IDLE”.

TABLE 8

| | Status information in NE#C | | | |
|---|---|---|---|---|
| Path | Received | Notified | Variable | |
| ID | information | information | factor | Route |
| #1 | WK | WK | — | NE#A-NE#B-NE#C |
| #2 | WK | WK | — | NE#A-NE#B-NE#C |
| #3 | IDLE | IDLE | — | NE#A-NE#B-NE#C |
| #4 | IDLE | IDLE | — | NE#A-NE#B-NE#C |
| #5 | WK | WK | — | NE#A-NE#D-NE#C |
| #6 | WK | WK | — | NE#A-NE#D-NE#C |
| #7 | WK | WK | — | NE#A-NE#D-NE#C |
| #8 | IDLE | IDLE | — | NE#A-NE#D-NE#C |

When a line disconnection occurs somewhere in the route of NE#A-NE#D-NE#C under the operation status shown in Table 8, the band management unit 17 of the sender NE#A 1a allows the traffic to make a detour to the route of NE#A-NE#B-NE#C. Since the unused capacity of the route of the NE#A-NE#B-NE#C is not sufficient for the detoured traffic amount, all the traffic cannot be detoured.

The band management unit 17 of the NE#A 1a allows the traffic to make a detour to the route of NE#A-NE#B-NE#C in order of the traffic going through a path having a high preset priority (see Table 1) among the paths #5 to #7. In the example in Table 1, since the priority of the paths #5 and #6 is “high” and the priority of the path #7 is “low”, the band management unit 17 directs the traffic going through the paths #5 and #6 to the paths #3 and #4, thereby relieving the traffic preferentially. The traffic going through the path #7 is relieved after a path is increased.

It is the same as in the case of the traffic relief example 1 described above that the status of the paths #3 and #4 is changed from “IDLE” to “WK” on the NE#A 1a side and the status of the paths #5 to #8 is changed to “FAULT” on the NE#C 1c side. The NE#C 1c transmits a status change report to the NMS 3, such as “#3, WK, connection failure”, “#4, WK, connection failure”, “#5, FAULT, connection failure”, “#6, FAULT, connection failure”, “#7, FAULT, connection failure”, and “#8, FAULT, connection failure”. The NMS 3 updates the database, such as “#3, IDLE→WK, connection failure”, “#4, IDLE→WK, connection failure”, “#5, WK→FAULT, connection failure”, “#6, WK→FAULT, connection failure”, “#7, WK→>FAULT, connection failure”, and “#8, IDLE→FAULT, connection failure”.

The operation status after the status change of the paths #3 to #8 is shown in Table 9.

TABLE 9

| | Status information in NE#C | | | |
|---|---|---|---|---|
| Path | Received | Notified | Variable | |
| ID | information | information | factor | Route |
| #1 | WK | WK | — | NE#A-NE#B- |
| | | | | NE#C |
| #2 | WK | WK | — | NE#A-NE#B- |
| | | | | NE#C |
| #3 | WK | WK | Connection | NE#A-NE#B- |
| | | | failure | NE#C |
| #4 | WK | WK | Connection | NE#A-NE#B- |
| | | | failure | NE#C |
| #5 | — | FAULT | Connection | NE#A-NE#D- |
| | | | failure | NE#C |
| #6 | — | FAULT | Connection | NE#A-NE#D- |
| | | | failure | NE#C |
| #7 | — | FAULT | Connection | NE#A-NE#D- |
| | | | failure | NE#C |
| #8 | — | FAULT | Connection | NE#A-NE#D- |
| | | | failure | NE#C |

It is assumed herein that line quality degradation occurs in a certain path, for example, the path #3, due to a fault in the NE somewhere in the route NE#A-E#B-NE#C under the operation status shown in Table 4, and the degraded quality falls below the lowest quality assurance level (see Table 1) preset for the path #3. In this case, the band management unit 17 of the NE#A 1a directs the traffic going through the path #3 to a path having a quality level equal to or higher than the quality assurance level set for the path #3 and having a space in the capacity, for example, to the path #5. At the same time, the band management unit 17 of the NE#A 1a changes the status of the path #3 from “WK” to “IDLE”, and changes the status of the path #5 from “IDLE” to “WK”.

After this, the processing is the same as in the case of traffic increase. That is, the NE#A 1a transmits the status change to the NE#C 1c, and the NE#C 1c transmits a status change report to the NMS 3, such as “#3, IDLE, quality degradation” and “#5, WK, quality degradation”. The NMS 3 updates the database for the paths #3 and #5, such as “#3, WK→IDLE, quality degradation” and “#5, IDLE→WK, quality degradation”.

The operation status after the status change of the paths #3 and #5 is shown in Table 10.

TABLE 10

| | Status information in NE#C | | | |
|---|---|---|---|---|
| Path | Received | Notified | Variable | |
| ID | information | information | factor | Route |
| #1 | WK | WK | — | NE#A-NE#B- |
| | | | | NE#C |
| #2 | WK | WK | — | NE#A-NE#B- |
| | | | | NE#C |
| #3 | IDLE | IDLE | Quality | NE#A-NE#B- |
| | | | degradation | NE#C |
| #4 | IDLE | IDLE | — | NE#A-NE#B- |
| | | | | NE#C |
| #5 | WK | WK | Quality | NE#A-NE#D- |
| | | | degradation | NE#C |
| #6 | IDLE | IDLE | — | NE#A-NE#D- |
| | | | | NE#C |
| #7 | IDLE | IDLE | — | NE#A-NE#D- |
| | | | | NE#C |
| #8 | IDLE | IDLE | — | NE#A-NE#D- |
| | | | | NE#C |

An example of a mounting location of the J1 byte used for the path trace function in the SONET/SDH is shown in FIG. 5. In the example shown in FIG. 5, VC3 containers are accommodated in STM 1 (155.52 Mbit/s). Path overhead (POH) is allocated to each container, and the J1 byte is arranged at the head of the POH.

According to the embodiment, when the status of use of the band changes in quite short time due to an abrupt increase or decrease of the traffic amount, occurrence or restoration of a fault, the sender NE#A 1a directs the traffic to an usable path without waiting for the permission of the NMS 3, and changes the status of the path. Accordingly, changes in the status of use of the band can be handled instantaneously. Furthermore, after detecting that the status of the path has been changed by the sender NE#A 1a, the destination NE#C 1c notifies the status change of the path to the NMS3. Accordingly, the NMS 3 can reliably recognize that the status of the path has been changed and update the database.

Different from the embodiment described above, in a system in which the NMS 3 controls the status change of the path, there is the possibility that the status of the path is not actually changed, though the NMS has changed the status of the path by the LCAS function. In such a situation, there are problems in that an increase or decrease of the traffic cannot be handled, and the traffic cannot be relieved in the case of line disconnection. The embodiment of the present invention can avoid such problems.

According to the embodiment, accurate operation status of the line can be obtained on the real-time basis by the path trace function, and essential information for the operation and management of the network can be provided to the user (a network manager). The network manager can make an efficient line plan based on the provided information.

The present invention is not limited to the embodiment, and can be variously changed. For example, the respective function units of the NMS 3 can be formed of hardware, or can be realized by executing a prepared program by a computer. The program is recorded on a computer readable recording medium such as a hard disk, a flexible disk, a CD-ROM, a magneto-optical (MO), or a digital versatile disk (DVD), and read from the recording medium and executed by the computer. The program can be distributed via a network such as the Internet. The same applies to the NEs 1a, 1b, 1c, and 1d.

According to the present invention, when the status of use of the band changes in quite short time due to an abrupt increase or decrease of the traffic amount, or occurrence or restoration of a fault, in a network system in which the VCAT and the LACAS are applied to the SONET/SDH to adjust the bands dynamically, the changes can be handled instantaneously.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmission device that uses a plurality of physically different physical paths as virtually one virtual path, comprising:
a band managing unit configured to monitor transmission status of a main signal and change a currently used physical path to another physical path in the virtual path based on the transmission status; and
a path trace managing unit configured to transmit information about the another physical path to a transmission device that is a destination of transmission of the main signal.

2. The transmission device according to claim 1, wherein, when a capacity of the current band is insufficient due to an increase in a traffic, the band managing unit uses an unused physical path in the virtual path as the another physical path.

3. The transmission device according to claim 1, wherein, when there is a space in the current band due to a decrease in a traffic, the band managing unit concentrates the traffic on the currently used physical path so as to make other physical paths in the virtual path idle.

4. The transmission device according to claim 1, wherein, when a certain physical path in the virtual path becomes faulty, the band managing unit directs the traffic going through faulty physical path to a normal physical path based on a priority specified beforehand.

5. The transmission device according to claim 1, wherein, when a line quality of a certain physical path in the virtual path degrades and falls below a threshold, the band managing unit directs a traffic going through the physical path whose line quality has fallen to a physical path whose line quality is above the threshold and having sufficient capacity.

6. The transmission device according to claim 1, wherein, when having received information about the another physical path from a transmission device that is the sender of the main signal, the band managing unit notifies change in the status of the physical path to a network management system that manages the entire network formed of a plurality of transmission devices.

7. The transmission device according to claim 1, wherein the band managing unit changes a status of the physical path through which no signal is transmitted from a transmission device that is a sender of the main signal to unusable, and notifies a change in the status of the physical path to the network management system that manages the entire network formed of a plurality of transmission devices.

8. The transmission device according to claim 1, wherein the band managing unit changes a physic path without interruption by using a link capacity adjustment scheme (LCAS).

9. A network management method of using a plurality of physically different physical paths as virtually one virtual path, comprising:
monitoring transmission status of a main signal;
changing a currently used physical path to another physical path in the virtual path based on the transmission status; and
transmitting information about the another physical path to a transmission device that is a destination of transmission of the main signal.

10. The network management method according to claim 9, wherein, when a result of the monitoring shows that a capacity of the current band is insufficient due to an increase in traffic, the changing includes changing the currently used physical path to an unused physical path in the virtual path.

11. The network management method according to claim 9, wherein, when a result of the monitoring shows that there is a space in the current band due to a decrease in traffic, the changing includes concentrating the traffic on the currently used physical path so as to make other physical paths in the virtual path idle.

12. The network management method according to claim 9, wherein, when a result of the monitoring shows that a certain physical path in the virtual path has become faulty, the changing includes directing the traffic going through faulty physical path to a normal physical path based on a priority specified beforehand.

13. The network management method according to claim 9, wherein, when a result of the monitoring shows that a line quality of a certain physical path in the virtual path has degraded and fallen below a threshold, the changing includes directing a traffic going through the physical path whose line quality has fallen to a physical path whose line quality is above the threshold and having sufficient capacity.

14. The network management method according to claim 9, wherein, when having received information about the another physical path from a transmission device that is the sender of the main signal, the method further includes notifying change in the status of the physical path to a network management system that manages the entire network formed of a plurality of transmission devices.

15. The network management method according to claim 9, wherein the changing includes changing a status of the physical path through which no signal is transmitted from a transmission device that is a sender of the main signal to unusable, and notifies a change in the status of the physical path to the network management system that manages the entire network formed of a plurality of transmission devices.

16. The network management method according to claim 14, wherein the network management system updates a database for managing the operation status of the entire network, based on the notification of the status change of the path transmitted from the transmission device, which is a destination of the main signal.

17. The network management method according to claim 15, wherein the network management system updates a database for managing the operation status of the entire network, based on the notification of the status change of the path transmitted from the transmission device, which is a destination of the main signal.

18. The network management method according to claim 9, wherein the changing includes changing physical path without interruption by using a link capacity adjustment scheme (LCAS).

19. A computer-readable recording medium configured to store therein a computer program that causes a computer to implement a network management method of using a plurality of physically different physical paths as virtually one virtual path, the computer program causing the computer to execute:
monitoring transmission status of a main signal;
changing a currently used physical path to another physical path in the virtual path based on the transmission status; and
transmitting information about the another physical path to a transmission device that is a destination of transmission of the main signal.
